(19) United States
(12) Patent Application Publication
(10) Pub. No.: US 2008/0259854 A1
(43) Pub. Date: Oct. 23, 2008

(54) Communication Terminal Apparatus, Base Station Apparatus, and Resource Assigning Method

(75) Inventor: Atsushi Sumasu, Kanagawa (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Matsushita Electric Industrial Co., Ltd., Kadoma-shi, Osaka (JP)

(21) Appl. No.: 11/909,974

(22) PCT Filed: Mar. 22, 2006
(86) PCT No.: PCT/JP2006/305728

§ 371 Date: Sep. 27, 2007

(30) Foreign Application Priority Data
Mar. 30, 2005 (JP) 2005-097963

(51) Int. Cl. H04J 11/00; H04Q 7/20

(52) U.S. Cl. 370/329

(57) ABSTRACT

A communication terminal apparatus of wireless communication system wherein the data amount of report values is reduced and the accuracy of the report values is enhanced in OFDM wireless communication. In a communication terminal apparatus (200), a reception quality measuring part (206) measures, based on information outputted from a demodulating part (205), the reception quality for each subcarrier. A block size deciding part (207) determines a coherent bandwidth for which the reception quality of each subcarrier is below a predetermined threshold value. The block size deciding part (207) then decides the coherent bandwidth as the block size of the subcarriers. A report value generating part (208) groups a plurality of subcarriers into a subcarrier block for each block size decided by the block size deciding part (207), averages the reception qualities, measured by the reception quality measuring part (206), for each subcarrier block, and generates reception quality information indicative of the reception quality average of each subcarrier block.

### TECHNICAL FIELD

The present invention relates to a communication terminal apparatus, base station apparatus and resource allocation method used in a radio communication of OFDM scheme.

### BACKGROUND ART

In HSDPA (High Speed Downlink Packet Access), standardized by 3GPP, a communication terminal apparatus measures the received quality of, for example, the SIR (Signal-to-Interference Ratio) per subcarrier and reports the received quality to a base station and the base station apparatus allocates radio resource based on, for example, the received quality reported from a plurality of communication terminal apparatuses and on the QoS (Quality of Service) information of the communication terminal apparatus.

However, in the case of radio communication using the OFDM scheme, there are approximately hundreds to a thousand subcarrier resources in the frequency domain and the band of signals transmitted from a base station apparatus to a communication terminal apparatus is quite broad. In this case, the resource allocation has a problem that the amount of report value data showing a result of the received quality measurement is large. Without special ingenuity, when L subcarriers are transmitted by M bits of information, L×M bits are needed, and, when N people transmit data in one ms cycle, the amount of data is L×M×N (kbps), that is, the amount of data is tens of mega bps. Therefore, the communication channel becomes busy.

Up till now, there are suggestions that solve the above problem. Patent-Document 1 and Non-Patent Document 1 decrease the number of report bits by reporting an average value of received quality per subcarrier block grouping a predetermined number of subcarriers. For example, when ten subcarriers are grouped to a subcarrier block, the amount of report value data can be reduced to one tenth.

Patent Document 1: Japanese Patent Application Laid-Open No. 2004-104574.

Non-Patent Document 1: MC-CDM System for Packet Communications Using Frequency Scheduling, Yoshitaka Hara, Takashi Kawabata, Jinsong Duan, Takashi Sekiguchi (Mitsubishi Electric Corporation), Technical Report of Institute of Electronics Information and Communication Engineers, RCS2002-129.

### DISCLOSURE OF INVENTION

### Problems to be Solved by the Invention

In the prior art, the width of a subcarrier block is fixed and received quality between subcarriers in a subcarrier block varies substantially under the transmission environment where frequency selective fading is large, and so, when an average value of received quality is reported per subcarrier block, the accuracy of received quality becomes less than when the received quality per subcarrier is reported.

It is therefore an object of the present invention to provide a communication terminal apparatus, base station apparatus and resource allocation method that can reduce the amount of report value data and enhance the accuracy of the report value.

### Means for Solving the Problem

In the present invention, a communication terminal apparatus in a radio communication system where a plurality of communication terminal apparatuses and a base station apparatus perform radio communication of an orthogonal frequency division multiplexing scheme and where the base station apparatus performs scheduling based on a report value showing received quality at the communication terminal apparatuses in communication, the communication terminal apparatus employs a configuration of having: areceived quality measuring section that measures received quality, per subcarrier, of a signal transmitted from the base station apparatus; a block size determining section that decides a coherence bandwidth where the received quality of each subcarrier stays within a predetermined threshold and that determines the coherence bandwidth as a subcarrier block size; a report value generating section that groups a plurality of subcarriers into a subcarrier block according to a block size decided by the block size determining section, finds an average of received quality per subcarrier block and generates received quality information showing the average received quality value per subcarrier block; and a transmitting section that transmits the received quality information and information showing the block size to the base station apparatus.

In the present invention, a communication terminal apparatus in a radio communication system where a plurality of communication terminal apparatuses and a base station apparatus perform a radio communication of an orthogonal frequency division multiplexing scheme and the ase station apparatus performs scheduling based on a report value showing the received quality of the communication terminal apparatuses in communication, the communication terminal apparatus employs a configuration of having: a demodulating section that demodulates information showing the block size determined by the communication terminal apparatuses and received quality information showing the average of received quality of subcarrier block according to the block size; and a scheduling section that performs a resource allocation based on the received quality information of each subcarrier block according to the block size.

In the present invention, a resource allocation method in which a plurality of communication terminal apparatuses and a base station apparatus perform radio communication of the base station apparatus performs scheduling based on a report value showing received quality of the communication terminal apparatuses in communication, the resource allocation method employs a configuration wherein: the communication terminal apparatuses decide a coherence bandwidth where the received quality of each subcarrier stays within a predetermined threshold as a subcarrier block size; the communication terminal apparatus groups a plurality of subcarriers into a subcarrier block per the block size, finds an average of received quality per subcarrier block and generates received quality information showing the average received quality value per subcarrier block; the communication terminal apparatus transmits the received quality information and information showing the block size; the base station apparatus demodulates the received quality information and information showing the block size; and the base station apparatus performs a resource allocation based on the received quality information per subcarrier block according to the block size.

### Advantageous Effect of the Invention

According to the present invention, by determining a coherence bandwidth where the received quality of each subcarrier stays within a predetermined threshold as the block size, the report value of each subcarrier block obtained by dividing all subcarriers by the coherence bandwidth can be generated. It is thereby possible to reduce the amount of report value data and improve the accuracy of the report values.

### BRIEF DESCRIPTION OF DRAWINGS

FIG. 1 is a block diagram showing a configuration of a base station apparatus according to Embodiment 1 of the present invention;

FIG. 2 is a block diagram showing a configuration of a communication terminal apparatus according to Embodiment 1 of the present invention;

FIG. 3 is a sequence diagram showing an order of the operation of a base station apparatus and communication terminal apparatus according to Embodiment 1 of the present invention;

FIG. 4 illustrates a method of deciding a coherence bandwidth of a communication terminal apparatus according to Embodiment 1 of the present invention;

FIG. 5 is a block diagram showing the configuration of a base station apparatus according to Embodiment 2 of the present invention; and

FIG. 6 is a block diagram showing the configuration of a communication terminal apparatus according to Embodiment 2 of the present invention.

### BEST MODE FOR CARRYING OUT THE INVENTION

Hereinafter, embodiments of the present invention will be explained in detail with reference to the attached drawings.

### Embodiment 1

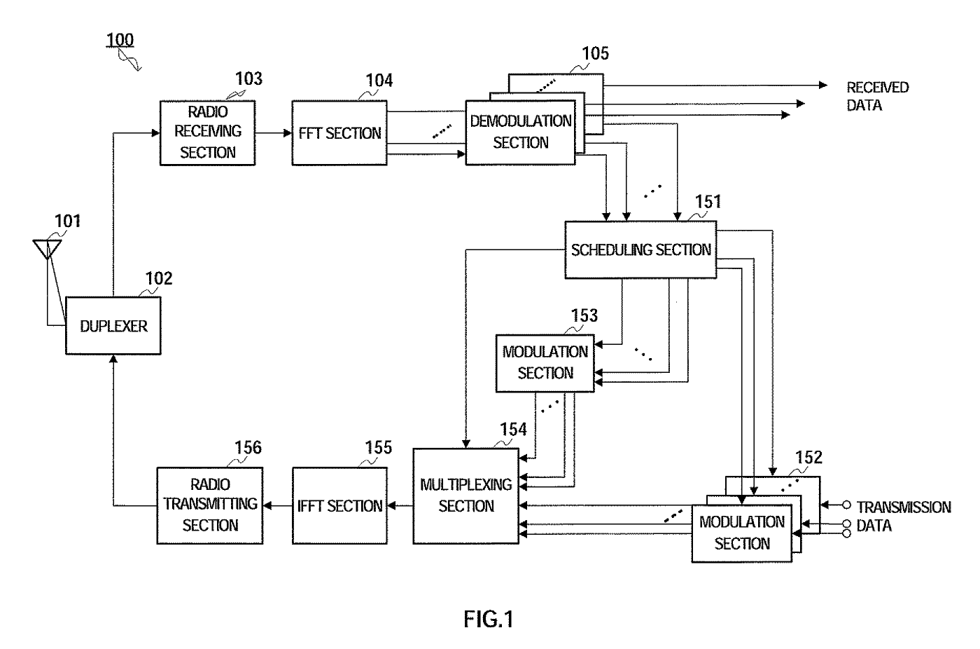

First, the configuration of the base station apparatus according to Embodiment 1 of the present invention will be described using the block diagram of FIG. 1. Base station 100 of FIG. 1 performs radio communication with a plurality of communication terminal apparatuses. Each communication terminal apparatus measures received quality per subcarrier, determines a block size based on the received quality of each subcarrier and reports information showing the block size (hereinafter “block size information”) to base station apparatus 100. Further, each communication terminal apparatus groups a plurality of subcarriers to a subcarrier block based on the block size information. Further, each communication terminal apparatus finds an average of received quality per subcarrier block and reports information showing the average of received quality of each subcarrier block (hereinafter “received quality information”) to base station apparatus 100.

Duplexer 102 outputs the signal received at antenna 101 to radio receiving section 103. Further, duplexer 102 transmits by radio the signal outputted from radio transmitting section 156 through antenna 101.

Radio receiving section 103 transforms the received radio frequency signal outputted from duplexer 102 to a baseband signal and outputs the transformed baseband signal to FFT section 104. FFT section 104 performs Fourier transform for the received baseband signal and outputs the signal after the Fourier transform to demodulation sections 105.

Demodulation sections 105, provided to equal the number of communication terminal apparatuses performing radio communication, each perform demodulation processing such as digital demodulation and error correcting decoding on the received base band signal after the Fourier transform, and obtain received data. Further, demodulation sections 105 separate received quality information and block size information incorporated in the received signal and outputs these separated information to scheduling section 151.

Scheduling section 151 allocates communication terminal apparatus showing data destination to each subcarrier block based on the block size information, based on received quality information, and determines the modulation scheme and coding rate of transmission data in each communication terminal apparatus (“resource allocation”).

An example of determining the modulation scheme and coding rate will be described below. First, received S/N to error rate characteristics are measured using modulation scheme and coding rate as parameter, and a table showing S/N that realizes a desired error rate, modulation scheme and coding rate is provided. In communication, received S/N is measured and the modulation scheme and coding rate corresponding to the received S/N are selected.

Scheduling section 151 outputs information showing subcarriers, the modulation scheme and coding rate (hereinafter “allocation information”) used for data transmission in each communication terminal apparatus to modulation section 153 after scheduling section 151 performs resource allocation. Further, scheduling section 151 specifies the modulation scheme and coding rate of modulation sections 152 and the order of multiplexing signals, inputted to multiplexing section 154, of multiplexing section 154.

Modulation sections 152, provided to equal the number of communication terminal apparatuses performing radio communication, each perform error correcting coding and digital modulation on transmission data for communication terminal apparatuses and output the transmission data after error correcting coding and digital modulation to multiplexing section 154 according to an instruction from scheduling section 151. Modulation section 153 performs error correcting coding and digital modulation on allocation information and outputs the allocation information after error correcting and digital modulation to multiplexing section 154.

Multiplexing section 154 multiplexes the output signals from modulation sections 152 and modulation section 153 and outputs a multiplex signal to IFFT section 155 according to an instruction from scheduling section 151.

IFFT section 155 performs inverse Fourier transform on the output signal from multiplexing section 154 and outputs the signal after the inverse Fourier transform to radio transmitting section 156. Radio transmitting section 156 transforms the baseband signal outputted from IFFT section 155 into a radio frequency signal and outputs the transformed radio frequency signal to duplexer 102.

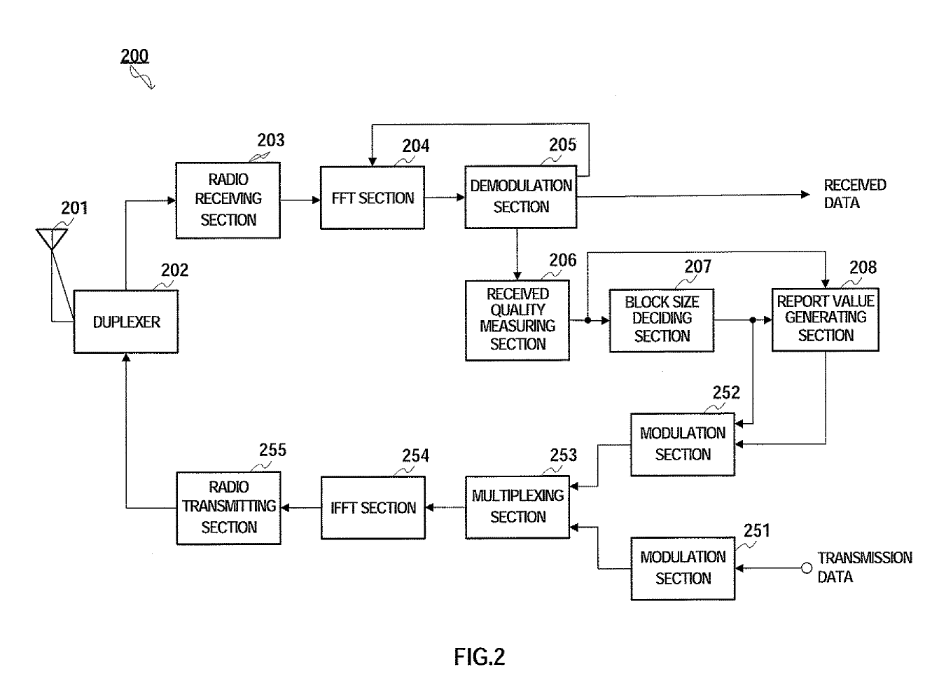

Next, the configuration of the communication terminal apparatus according to the present embodiment will be described using the block diagram of FIG. 2. Communication terminal apparatus 200 of FIG. 2 performs radio communication with base station apparatus 100 described in FIG. 1 and receives a radio signal including allocation information.

Duplexer 202 outputs the signal received at antenna 201 to radio receiving section 203. Further, duplexer 202 transmits by radio the signal outputted from radio transmitting section 255 through antenna 201.

Radio receiving section 203 transforms the radio frequency signal outputted from duplexer 202 into a baseband signal and outputs the transformed baseband signal to FFT section 204. FFT section 204 performs Fourier transform on the received baseband signal and outputs the subcarrier signal after Fourier transform, the subcarrier shown in allocation information, to demodulation section 205.

Demodulation section 205 performs processing such as digital demodulation and error correcting decoding on the received baseband signal after the Fourier transform, and obtains received data. Further, demodulation section 205 separates allocation information incorporated in the received signal and outputs the separated received signal to FFT section 204. Further, demodulation section 205 outputs information required for measuring received quality, for example, channel estimation value, desired signal power and interference signal power of each subcarrier obtained in the process of demodulation processing to received quality measuring section 206.

Received quality measuring section 206 measures received quality per subcarrier based on information outputted from demodulation section 205 and outputs information showing the measured received quality to block size determining section 207 and report value generating section 208.

Block size determining section 207 decides a coherence bandwidth where the received quality of subcarriers stays within a predetermined threshold. Further, block size determining section 207 determines the coherence bandwidth as the subcarrier block size and outputs block size information showing the decided block size to report value generating section 208 and modulation section 252. Further, the method of deciding the coherence bandwidth in block size determining section 207 will be described in detail later.

Report value generating section 208 groups a plurality of subcarriers to a subcarrier block according to the block size determined by block size determining section 207. Further, report value generating section 208 finds an average of received quality measured by received quality measuring section 206 per subcarrier block and generates received quality information showing the average value of received quality of each subcarrier block. Report value generating section 208 outputs the generated received quality information to modulation section 252.

Modulation section 251 performs error correcting coding and digital modulation on data transmitted to base station apparatus 100 and outputs the data after error correcting coding and digital modulation to multiplexing section 253. Modulation section 252 performs error correcting coding and digital modulation on received quality information and block size information and outputs these information after error correcting coding and digital modulation to multiplexing section 253.

Multiplexing section 253 multiplexes the output signals of modulation section 251 and modulation section 252 and outputs the multiplex signal to IFFT section 254. IFFT section 254 performs inverse Fourier transform on the output signal in multiplexing section 253 and outputs the signal after inverse Fourier transform to radio transmitting section 255. Radio transmitting section 255 transforms the baseband signal outputted from IFFT section 254 into a radio frequency signal and outputs the transformed signal to duplexer 202.

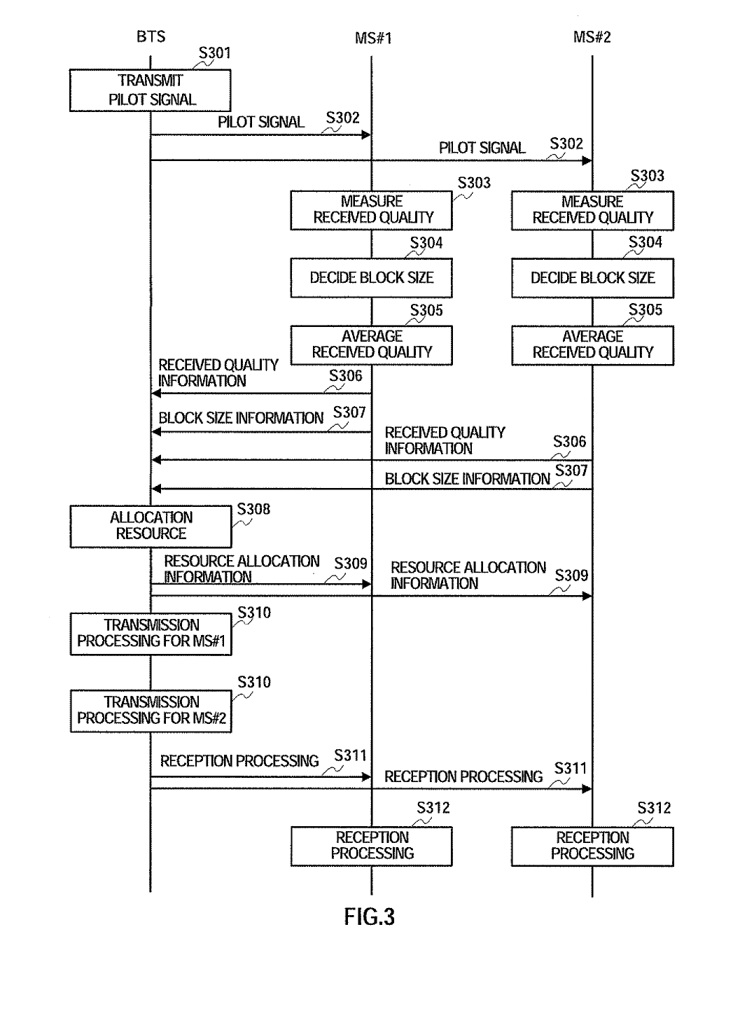

Next, the order of operations of base station apparatus and communication terminal apparatus will be described using the sequence diagram of FIG. 3. Further, in FIG. 3, base station apparatus (BTS) is assumed to be in communication with two communication terminal apparatuses (MS#1 and MS#2).

First, base station apparatus transmits a pilot signal to each communication terminal apparatus (S301 and S302).

Each communication terminal apparatus measures the received quality of received pilot signal per subcarrier (S303), decides the coherence bandwidth based on the received quality of each subcarrier and determines the coherence bandwidth as the subcarrier block size (S304). Further, each communication terminal apparatus finds an average of received quality for each block of subcarriers grouped on a per block size basis (S305) and transmits received quality information showing the average value of received quality of each subcarrier block and block size information showing the block size to the base station apparatus (S306 and S307).

A base station apparatus performs resource allocation on each subcarrier block according to block size information, based on the received quality information received from communication terminal apparatuses (S308). Further, the base station apparatus transmits allocation information showing a result of resource allocation to each communication terminal apparatus (S309) and transmits data to each communication terminal apparatus using the subcarrier determined by resource allocation (S310 and S311).

Each communication terminal apparatus performs Fourier transform on the subcarriers in the received signal, the subcarrier shown in allocation information, and obtains received data (S312).

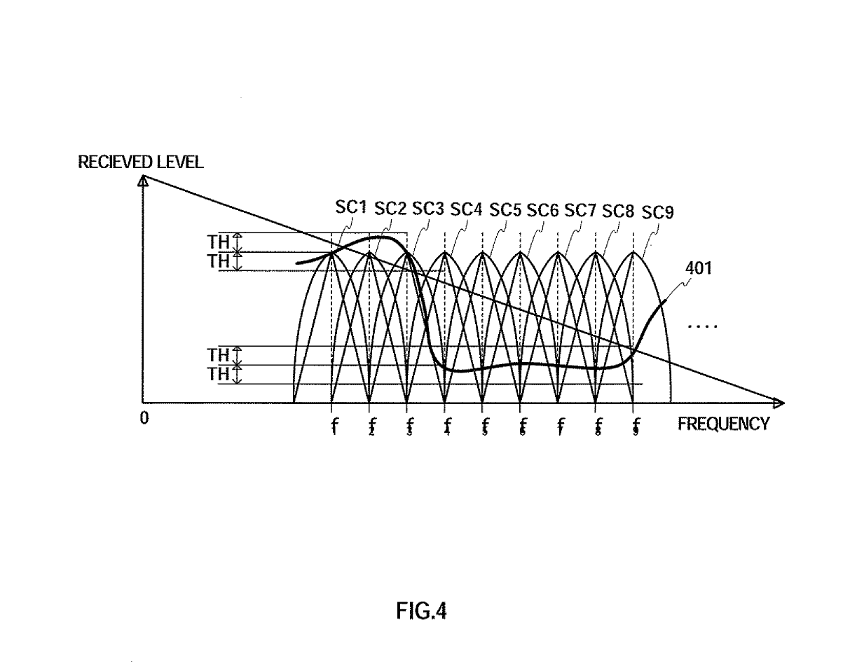

Next, the method of determining the coherence bandwidth in block size determining section 207 will be described in detail using FIG. 4. In FIG. 4, the horizontal axis is frequency and the vertical axis is received level. Further, SC1 to SC9 are subcarriers having a center frequencies f1 to f9, respectively, and curve 401 is the level of received signal (received quality).

Block size determining section 207, making one subcarrier a reference subcarrier, finds the difference in received quality with respect to the reference subcarrier from the nearest subcarrier from the reference subcarrier, sequentially, and decides the frequency bandwidth where the absolute value of the difference in the received quality stays within a predetermined threshold as the coherence bandwidth.

For example, in FIG. 4, if SC1 is the reference subcarrier, first, block size determining section 207 decides whether or not the difference in received quality between SC1 and SC2 stays within predetermined threshold TH.

In FIG. 4, the difference in received quality between SC1 and SC2 stays within threshold TH, and so, block size determining section 207 decides whether or not the difference in received quality between SC1 and SC3 stays within predetermined threshold TH.

In FIG. 4, the difference in received quality between SC1 and SC3 stays within threshold TH, and so, block size determining section 207 decides whether or not the difference in received quality between SC1 and SC4 stays within predetermined threshold TH.

In FIG. 4, the difference in received quality between SC1 and SC4 is over threshold TH and block size determining section 207 decides frequency bandwidth between the center frequency of SC1, f1, and the center frequency of SC3, f3.

Block size determining section 207 decides SC4 as the reference subcarrier, and, similarly, finds the difference in received quality in response to SC4 from the nearest subcarrier from SC4, sequentially. As a result, block size determining section 207 decides the frequency bandwidth between the center frequency of SC4, f4, and the center frequency of SC9, f9, as the next coherence bandwidth.

As described above, according to the present embodiment, it is possible to generate a report value per subcarrier block obtained by dividing all subcarriers to the coherence bandwidth, by deciding a coherence bandwidth where the received quality of each subcarrier stays within a predetermined threshold and determining the coherence bandwidth as the block size. By doing so, it is possible to reduce the amount of report value data and enhance the accuracy of the report value.

Although a case has been described above description where a coherence bandwidth is determined a plurality of times (several times) and the block size changes every time, it is equally possible to find an average of the sequentially-determined coherence bandwidth in the end and determine a uniform block size. By unifying the block size, the number of block size reported is one, so that it is possible to reduce the amount of report value data further.

### Embodiment 2

A case will be described with Embodiment 2 of the present invention where the threshold used to decide the coherence bandwidth is controlled depending on QoS (Quality of Service) will be described.

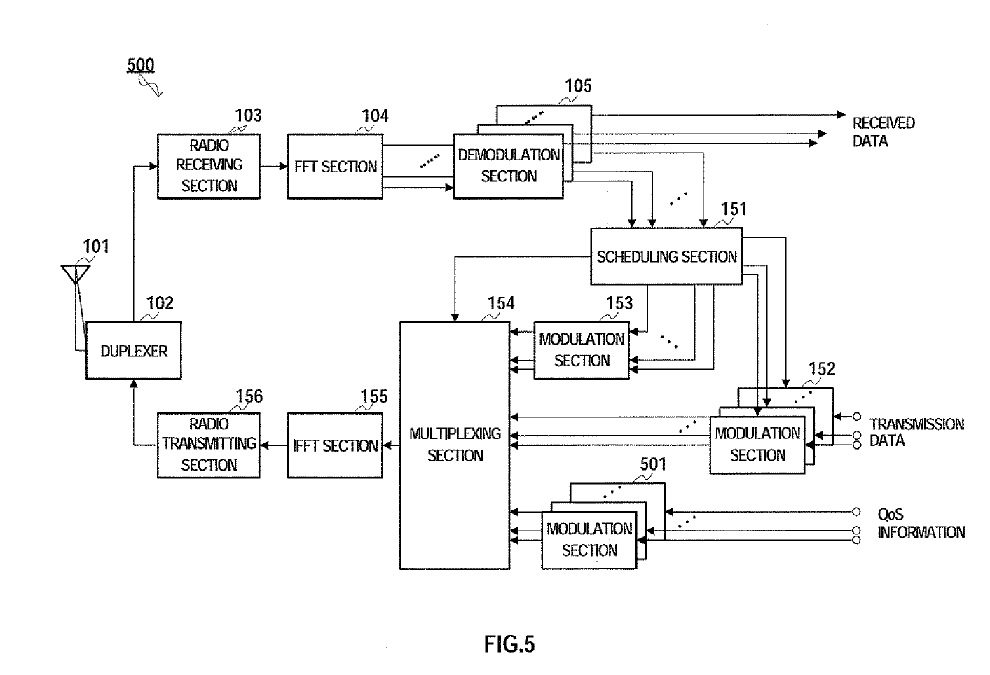

FIG. 5 is a block diagram showing the configuration of the base station apparatus according to the present embodiment. In base station apparatus 500 of FIG. 5, the same components as those explained in base station 100 of Embodiment 1 are assigned the same reference numerals and detailed explanations thereof will be omitted. Base station apparatus 500 of FIG. 5 employs a configuration that adds modulation sections 501 to base station 100 of FIG. 1.

Modulation sections 501, provided to equal the number of communication terminal apparatuses performing radio communication, each perform error correcting coding and digital modulation on QoS information and output the QoS information after error correcting coding and digital coding to multiplexing section 154. Multiplexing section 154 multiplexes output signals of modulation sections 152, modulation section 153 and modulation sections 501 according to an instruction from scheduling section 151 and outputs the multiplex signal to IFFT section 155.

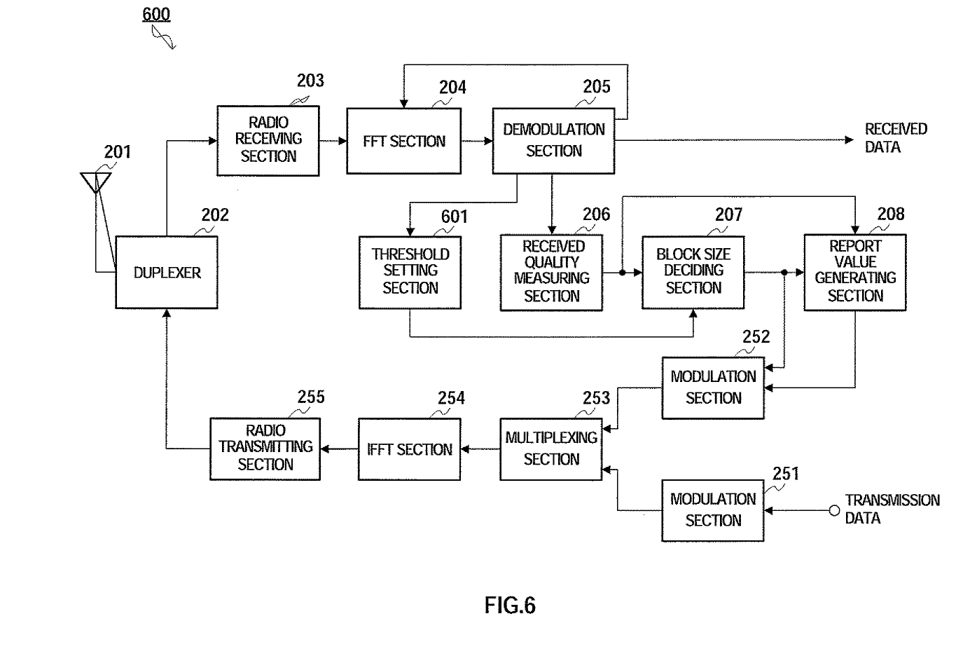

Next, the configuration of the communication terminal apparatus according to the present embodiment will be described using the block diagram of FIG. 6. Communication terminal apparatus 600 of FIG. 6 performs radio communication with base station apparatus 500 shown in FIG. 5 and receives a radio signal including allocation information and QoS information.

Further, in communication terminal apparatus 600 of FIG. 6, the same components as communication terminal apparatus 200 shown in FIG. 2 are assigned the same reference numerals and detailed explanations thereof will be omitted. Communication terminal apparatus 600 of FIG. 6 employs a configuration that adds threshold setting section 601 to communication terminal apparatus 200 of FIG. 2.

Demodulation section 205 performs demodulation processing such as digital demodulation and error correcting decoding on the received baseband after Fourier transform and obtains received data. Further, demodulation section 205 separates allocation information incorporated in the received data and outputs the separated information to FFT section 204. Further, demodulation section 205 separates QoS information incorporated in the received data and outputs the separated information to threshold setting section 601. Further, demodulation 205 outputs information required for measuring received quality, for example, channel estimation value, desired signal power or interference signal power of each subcarrier obtained in the process of demodulation processing to received quality measuring section 206.

Threshold setting section 601 sets the threshold according to QoS information and outputs information showing the set threshold to block size deciding section 207. For example, detailed transmission control is requested for services where required transmission speed is high or the amount of allowed delay is small, and threshold setting section 601 sets a smaller threshold. By contrast, rough transmission control is allowed for services where required transmission speed is low or the amount of allowed delay is large, and threshold setting section 601 sets a larger threshold.

Block size determining section 207 decides a coherence bandwidth where the received quality of each subcarrier stays within the threshold set by threshold setting section 601. Further, block size determining section 207 decides the coherence bandwidth as the subcarrier block size and outputs block size information showing the determined block size, to report value generating section 208 and modulation section 252.

As a result, the subcarrier block size becomes smaller for services where required transmission speed is high or the amount of allowed delay is small, so that it is possible to improve the accuracy of report value and perform control such as resource allocation correctly, and perform communication more successfully. By contrast, the subcarrier block size becomes bigger for services where required transmission speed is low or the amount of allowed delay is large, so that it is possible to reduce the amount of report value data.

As described above, according to the present embodiment, the threshold used to decide the coherence bandwidth can be controlled according to QoS information, so that it is possible to reduce the amount of report value data and improve the accuracy of report value within a range of the requirement for QoS is satisfied.

Further, although a case has been described above with the present embodiment where a base station apparatus transmits QoS information to each communication terminal apparatus and each communication terminal apparatus sets the threshold according to QoS information, the present invention is not limited to the above case and it is possible to have the base station apparatus that sets the threshold according to QoS information and transmits information showing the threshold to each communication terminal apparatus.

Further, although a case has been described above where OFDM transmission is performed on the uplink channel where transmission is performed from a communication terminal apparatus, in the present invention, it is possible to perform the OFDM transmission on only the downlink channel where transmission is performed from a base station and employ transmission systems (for example, spectrum spread system) other than OFDM on the uplink channel. Further, in the present invention, it is possible to employ a transmission system such as OFDM-CDMA combining multicarrier transmission and spread spectrum technique.

The present application is based on Japanese Patent Application No. 2005-097963, filed on Mar. 30, 2005, the entire content of which is expressly incorporated by reference herein.

### INDUSTRIAL APPLICABILITY

The present invention is preferably used for a base station apparatus and communication terminal apparatus that performs radio communication of the OFDM system.

1. A communication terminal apparatus in a radio communication system where a plurality of communication terminal apparatuses and a base station apparatus perform radio communication of an orthogonal frequency division multiplexing scheme and where the base station apparatus performs scheduling based on a report value showing received quality at the communication terminal apparatuses in communication, the communication terminal apparatus comprising:
a received quality measuring section that measures received quality, per subcarrier, of a signal transmitted from the base station apparatus;
a block size determining section that decides a coherence bandwidth where the received quality of each subcarrier stays within a predetermined threshold and that determines the coherence bandwidth as a subcarrier block size;
a report value generating section that groups a plurality of subcarriers into a subcarrier block according to a block size decided by the block size determining section, finds an average of received quality per subcarrier block and generates received quality information showing the average received quality value per subcarrier block; and
a transmitting section that transmits the received quality information and information showing the block size to the base station apparatus.

2. The communication terminal apparatus according to claim 1, wherein the block size determining section finds an average of a plurality of coherence bandwidths and fixes the block size.

3. The communication terminal apparatus according to claim 1, further comprising a threshold setting section that sets a threshold used to decide a coherence bandwidth according to quality of service, wherein the block size determining section decides a coherence bandwidth where the received quality of each subcarrier stays within the threshold set by the threshold setting section.

4. The communication terminal apparatus according to claim 3, wherein the threshold setting section makes the threshold smaller for a service where required transmission speed is fast or the amount of allowed delay is small.

5. A communication terminal apparatus in a radio communication system where a plurality of communication terminal apparatuses and a base station apparatus perform a radio communication of an orthogonal frequency division multiplexing scheme and the base station apparatus performs scheduling based on a report value showing the received quality of the communication terminal apparatuses in communication, the communication terminal apparatus comprising:
a demodulating section that demodulates information showing the block size determined by the communication terminal apparatuses and received quality information showing the average of received quality of subcarrier block according to the block size; and
a scheduling section that performs a resource allocation based on the received quality information of each subcarrier block according to the block size.

6. A resource allocation method in which a plurality of communication terminal apparatuses and a base station apparatus perform radio communication of orthogonal frequency division multiplexing scheme and where the base station apparatus performs scheduling based on a report value showing received quality of the communication terminal apparatuses in communication, wherein:
the communication terminal apparatuses decide a coherence bandwidth where the received quality of each subcarrier stays within a predetermined threshold as a subcarrier block size;
the communication terminal apparatus groups a plurality of subcarriers into a subcarrier block per the block size, finds an average of received quality per subcarrier block and generates received quality information showing the average received quality value per subcarrier block;
the communication terminal apparatus transmits the received quality information and information showing the block size;
the base station apparatus demodulates the received quality information and information showing the block size; and
the base station apparatus performs a resource allocation based on the received quality information per subcarrier block according to the block size.
